(19) United States
(12) Patent Application Publication
(10) Pub. No.: US 2012/0242082 A1
(43) Pub. Date: Sep. 27, 2012

(54) Fine Thread to Standard Garden Hose Thread Adapter

(75) Inventors: Gregory Neil Larsen, Beaverton, OR (US); Shana Ann Larsen, Beaverton, OR (US); Shana Ann Larsen, Beaverton, OR (US)

(73) Assignees: Gregory Neil Larsen, Beaverton, OR (US); Spigotmaster, Beaverton, OR (US); Shana Ann Larsen, Beaverton, OR (US)

(21) Appl. No.: 13/072,410

(22) Filed: Mar. 25, 2011

(51) Int. Cl. F16L 55/00

(52) U.S. Cl. 285/148.19

(57) ABSTRACT

An innovative adapter replacing current outdoor hose bib anti siphon devices that are under pressure. The adapter is designed specifically to be threaded onto the fine thread of an Arrowhead® spigot, and connect easily to a standard garden hose thread. This enables the system to be put under pressure by a watering timer, or other pressurizing device, without leaking.

### BACKGROUND OF THE INVENTION

In homes built after 1990, due to a building code improvement, the outdoor hose spigot may have an anti-siphon device attached to it. The anti-siphon device is designed to stop the garden hose from sucking up dirty water, lawn or yard chemicals, pool chlorine, etc. into the household drinking water.

These anti-siphon devices are an improvement, unless attached to a pressurizing device like a water timer. Anti-siphon devices are designed to leak when under pressure, defeating the purpose and usefulness of a water timer or similar device. The obvious solution is to remove the anti-siphon device, attach the water timer, then replace the anti siphon device down-flow from the spigot and timer.

However if the home was built using an anti-siphon device manufactured by Arrowhead® Brass Products, then the simple solution does not work. The prior art Arrowhead® anti-siphon device is attached to the spigot using a non-standard thread. Because of this non-standard thread, a standard garden hose adapter and other threaded pipe connections will not work with the spigot after the anti-siphon device is removed. In fact it may cause damage.

Current solutions to the problem include replacing the outdoor hose bib or forcing the timer (or similar device) onto the hose bib using plumber's tape. An Arrowhead® system includes an anti-frost solution that reaches 6 to 18 inches into the wall of the house, turning this simple problem into a major plumbing and renovation project that includes cutting into the exterior wall of the home. The plumber's tape in time will fail and result in a leaky spigot. Neither of these solutions is adequate.

### SUMMARY OF INVENTION

The present invention solves the foregoing problems by replacing the anti siphon mechanism with an adapter that easily threads onto both the Arrowhead® hose bib and accepts the standard garden hose thread of a timer or other pressurizing device.

Those skilled in the art will recognize that garden hose treaded couplings are indeed standardized in the industry. In fact, no matter what the size of the garden hose, the various threaded male and female connectors will mate. Plastic and brass connectors will typically mate. Connectors from different manufacturers will mate. (As previously disclosed in now-expired U.S. Pat. No. 6,006,961)

The adapter is a tubular design, with fine threaded female and garden hose threaded male ends, which allows water to flow adequately without obstruction. The fine thread to hose thread adapter of the present invention accepts a vinyl washer to create a watertight seal between the adapter and hose bib. The adapter also has external grooves on the body so it can be easily gripped and hand tightened with enough torque to create a watertight seal.

### BRIEF DESCRIPTION OF THE DRAWINGS

FIG. 1. A side cut away view of the adapter, according to the present invention; and

FIG. 2. A side view example of the invention in use, showing an outdoor spigot, followed by the invention, pressurizing device, anti siphon device and hose in sequence.

### DETAILED DESCRIPTION OF THE ILLUSTRATED EMBODIMENTS

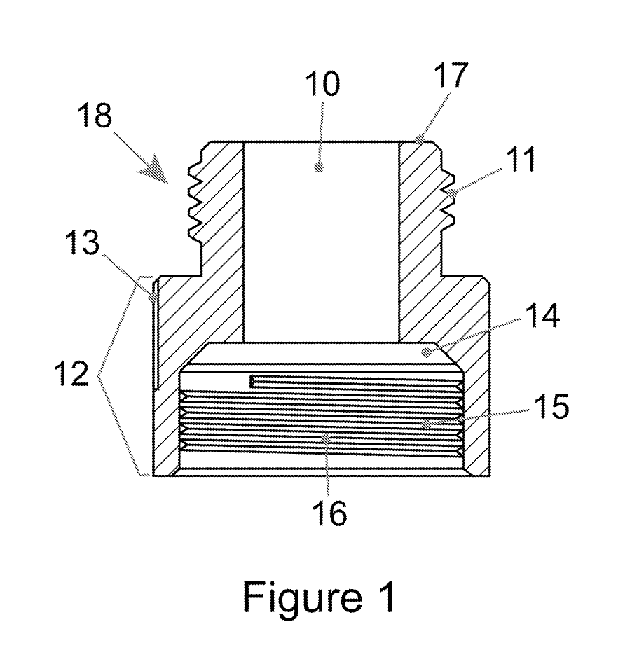

Referring to FIG. 1, the tubular body 18 has main through passage between the female entrance opening 16 and male exit opening 10. The male end is shown with a standard garden hose thread 11 which then transitions to the body 12. In order to provide leverage while attaching the device, grips 13 are included on the outside body 12. Within the interior of the female opening 16, a shelf 14 is designed to fit a vinyl washer, so that the fine threads 15, that attach to the Arrowhead® spigot, can form a watertight connection. On the male end, a flat surface 17 is designed to form a watertight seal with a hose washer.

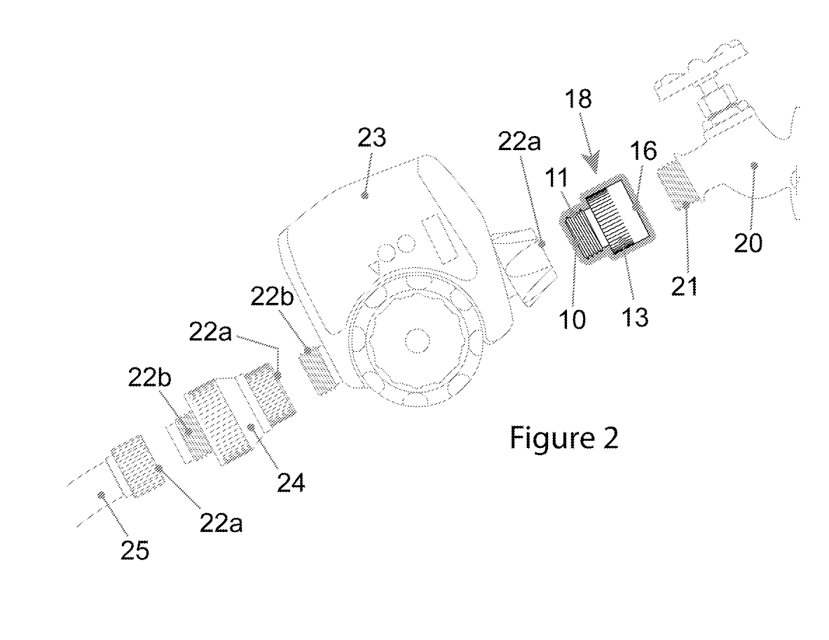

Referring to FIG. 2, the Arrowhead® spigot 20, shown with the fine Arrowhead® thread 21, attaches to the invention's fine-threaded end 16. The standard garden hose thread of the invention 11 attaches to the female connection 22a of the water timer or other pressurizing device 23. The male connection 22b of the water timer 23 attaches to an anti siphon device 24 with standard garden hose thread connection. FIG. 3 shows how to move the anti siphon device 24 downstream of the pressurizing device 23, aided with the invention 18. The standard hose thread of the anti siphon device can then be attached to a standard garden hose 25.

We accordingly claim:

1. A spigot adapter system comprising:
an adapter with fine threads; and
a washer shelf; and
grips for tightening, that adapts to a standard garden hose thread.

2. The spigot adapter system of claim 1, wherein said fine thread is specifically designed to mate with an Arrowhead® spigot.

3. The spigot adapter system of claim 2, wherein said washer shelf is designed to receive a standard garden hose vinyl washer, or other like material. The design of the adapter and washer is intended to be hand-tightened to provide a watertight seal.

4. The spigot adapter system of claim 3, wherein said grips are used to assist with tightening by hand the adapter to the spigot.

5. The spigot adapter system of claim 4, once the adapter is mated to the Arrowhead® spigot, the invention can be used with any standard garden hose device.
